(19) United States
(12) Patent Application Publication
(10) Pub. No.: US 2026/0161197 A1
(43) Pub. Date: Jun. 11, 2026

(54) FLEXIBLE DISPLAY DEVICE METAL SUPPORT, MANUFACTURING METHOD THEREOF, AND FLEXIBLE DISPLAY DEVICE

(71) Applicant: DAI NIPPON PRINTING CO., LTD., Tokyo-to (JP)

(72) Inventors: Masao FUKUSHIMA, Tokyo-to (JP); Masanobu NAKANO, Tokyo-to (JP); Shinichiro TAKAHASHI, Tokyo-to (JP)

(73) Assignee: DAI NIPPON PRINTING CO., LTD., Tokyo-to (JP)

(21) Appl. No.: 18/971,467

(22) Filed: Dec. 6, 2024

(51) Int. Cl. G06F 1/16

(52) U.S. Cl. CPC G06F 1/1641; G06F 1/1652

(57) ABSTRACT

A flexible display device metal support includes a base material having a first surface and a second surface. The base material includes a through hole and at least two through-hole sidewall surfaces facing each other, with the through hole therebetween. Each of the two through-hole sidewall surfaces includes a first-surface-side taper surface formed in such a manner that the through hole becomes wider from a side where the second surface is located toward a side where the first surface is located.

### CROSS-REFERENCE TO RELATED APPLICATIONS

The present invention contains subject matter related to Japanese Patent Application No. 2022-212450 filed in the Japan Patent Office on Dec. 28, 2022, the entire contents of which are incorporated herein by reference.

### BACKGROUND OF THE INVENTION

### 1. Field of the Invention

The present disclosure relates to a flexible display device metal support, a manufacturing method thereof, and a flexible display device.

### 2. Description of the Related Art

These days, for example, in the field of display devices of smartphones, tablets, and the like, those having a collapsible structure are known. A flexible display device having a bendable portion at its part exists as such a kind of display device, for example, as disclosed in Japanese U.S. Pat. No. 6,603,764.

These days, it is demanded to reduce the shape size of the bent portion when a flexible display device is folded. That is, it is demanded to reduce the radius of curvature of the bent portion. However, the smaller the shape size of the bent portion is, the more difficult it is to maintain the strength of the bent portion.

### SUMMARY OF THE INVENTION

The present disclosure provides a flexible display device metal support that makes it possible to reduce the radius of curvature of the bent portion of a flexible display device, a manufacturing method thereof, and the flexible display device.

Embodiments of the present disclosure relate to [1] to [9] stated below.

[1] A flexible display device metal support, comprising: a base material having a first surface and a second surface, the base material including: a through hole; and at least two through-hole sidewall surfaces facing each other, with the through hole therebetween, wherein each of the two through-hole sidewall surfaces includes a first-surface-side taper surface formed in such a manner that the through hole becomes wider from a side where the second surface is located toward a side where the first surface is located.

[2] The flexible display device metal support according to [1], wherein

each of the two through-hole sidewall surfaces includes a second-surface-side taper surface formed in such a manner that the through hole becomes wider from the side where the first surface is located toward the side where the second surface is located.

[3] The flexible display device metal support according to [2], wherein

a lateral protrusion is formed between the first-surface-side taper surface and the second-surface-side taper surface.

[4] The flexible display device metal support according to [3], wherein

the lateral protrusion is located at a midpoint between the first surface and the second surface.

[5] The flexible display device metal support according to [3], wherein the lateral protrusion is located at a position closer to the second surface than a midpoint between the first surface and the second surface is.

[6] The flexible display device metal support according to any one of to [5], including: a bending area; and a non-bending area, wherein a thickness of the base material at the non-bending area and a thickness of the base material at the bending area are different from each other.

[7] The flexible display device metal support according to [6], wherein in the bending area, a second-surface-side protrusion is formed at the side, of the base material, where the second surface is located.

[8] A flexible display device, comprising: a display member; and the flexible display device metal support according to any one of [1] to [7] supporting the display member.

[9] A method of manufacturing a flexible display device metal support, comprising: preparing a base material having a first surface and a second surface; and forming a through hole and at least two through-hole sidewall surfaces facing each other, with the through hole therebetween, in the base material by etching the base material, wherein each of the two through-hole sidewall surfaces includes a first-surface-side taper surface formed in such a manner that the through hole becomes wider from a side where the second surface is located toward a side where the first surface is located.

The present disclosure makes it possible to reduce the radius of curvature of the bent portion of a flexible display device.

### BRIEF DESCRIPTION OF DRAWINGS

FIG. 1 is a perspective view illustrating a flexible display device according to an embodiment.

FIG. 2 is a plan view illustrating a flexible display device according to an embodiment.

FIG. 3 is a cross-sectional view illustrating a flexible display device according to an embodiment (in an expanded state) (cross-sectional view taken along a line III-III of FIG. 2).

FIG. 4 is a cross-sectional view illustrating a flexible display device according to an embodiment (in a folded state).

FIG. 5 is a plan view illustrating a flexible display device metal support according to an embodiment.

FIG. 6 is a partial cross-sectional view illustrating a flexible display device metal support according to an embodiment (cross-sectional view taken along a line VI-VI of FIG. 5).

FIGS. 7A and 7B are plan views illustrating a flexible display device metal support according to variation examples.

FIG. 8 is a cross-sectional view illustrating a flexible display device metal support according to a variation example.

FIGS. 9A to 9D are cross-sectional views illustrating a method of manufacturing a flexible display device metal support according to an embodiment.

FIG. 10 is a cross-sectional view illustrating a state in which the flexible display device metal support is bent.

### DETAILED DESCRIPTION OF THE INVENTION

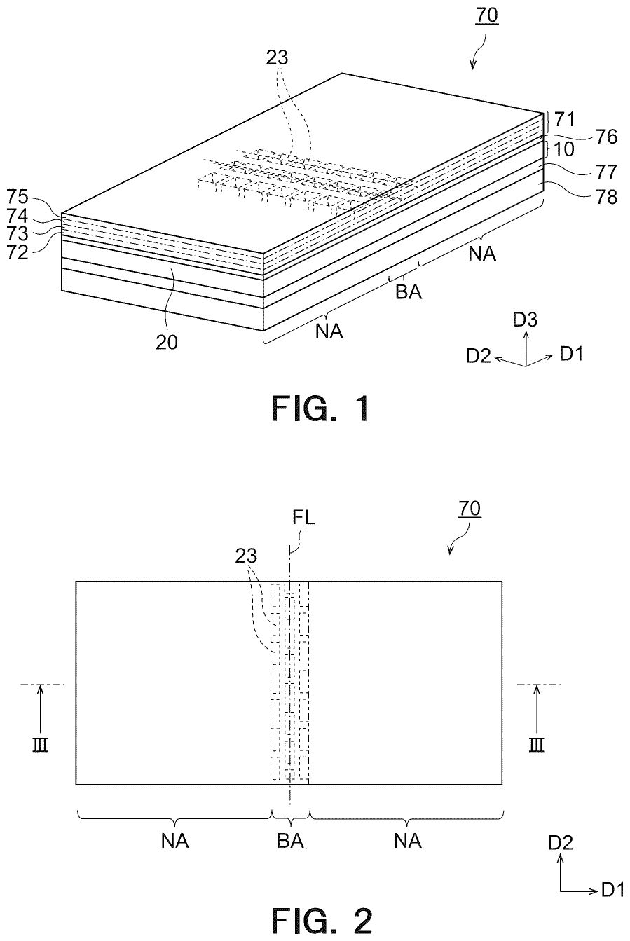

With reference to FIGS. 1 to 10, an embodiment of the present disclosure will now be described. In each of the drawings to which reference is made below, the same reference signs are assigned to the same portions, and a detailed explanation thereof may sometimes be partially omitted.

In this specification, the term “first direction D1” means a direction that lies on a plane parallel to a principal surface of a flexible display device metal support 10 or a flexible display device 70 and is perpendicular to a folding center line FL. The term “second direction D2” means a direction that lies on a plane parallel to a principal surface of the flexible display device metal support 10 or the flexible display device 70 and is parallel to the folding center line FL. The first direction D1 and the second direction D2 may be directions that are parallel to the sides of the flexible display device metal support 10 or the flexible display device 70 respectively. The first direction D1 and the second direction D2 are orthogonal to each other. A third direction D3 is a direction that is perpendicular to both the first direction D1 and the second direction D2 and is parallel to the thickness direction of the flexible display device metal support 10 or the flexible display device 70.

Configuration of Flexible Display Device First, with reference to FIGS. 1 to 4, an overview of a flexible display device according to the present embodiment is presented below. FIGS. 1 to 4 are diagrams illustrating a flexible display device according to the present embodiment.

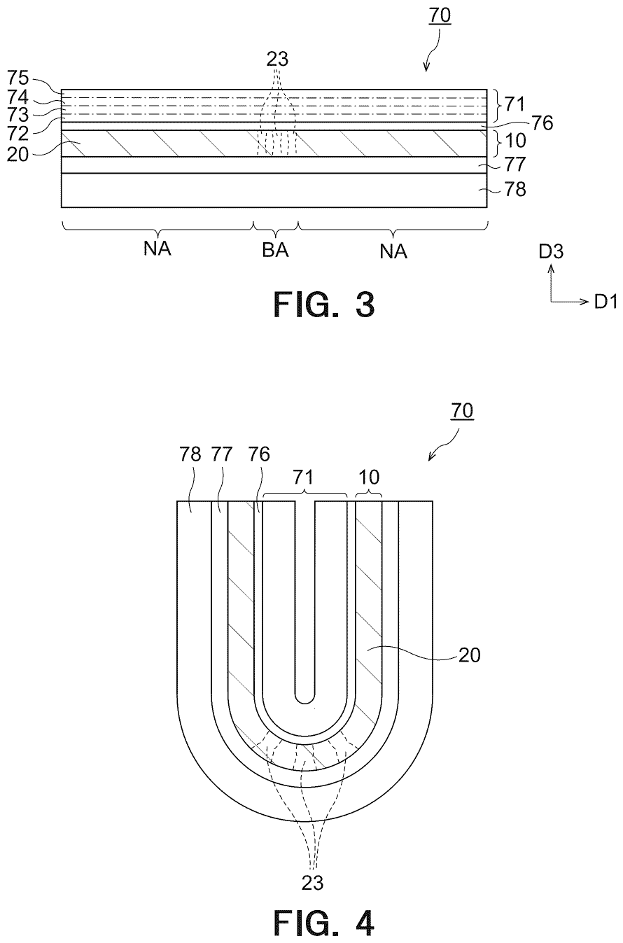

The flexible display device 70 illustrated in FIGS. 1 and 2 may be, for example, an organic electroluminescent (EL) display device. The flexible display device 70 is flexible and has a foldable structure. That is, the flexible display device 70 can be put into a folded state (see FIG. 4), which means a state of being collapsed, and an expanded state (see FIGS. 2 and 3), which means a state of being opened. The folded state is a state in which the flexible display device 70 is folded at its center along the folding center line FL. The folding is performed such that a part of an outer surface of a display member 71 and another part of the outer surface thereof are positioned close to each other in the folded state. Note that this does not imply any limitation. The folding may be performed in such a way as to bring a part of an outer surface of a casing 78 and another part of the outer surface thereof close to each other. The expanded state is a state in which the flexible display device 70 is open without being folded. In the expanded state, the entire surface of the display member 71 lies on substantially the same plane. Such a flexible display device 70 may be thin electronic equipment that has a section configured to display an image. Such electronic equipment may be, for example, portable terminal equipment such as a smartphone or a tablet.

As illustrated in FIG. 3, the flexible display device 70 includes the display member 71 and the flexible display device metal support 10 (hereinafter simply referred to also as “metal support 10”) supporting the display member 71. A cushioning layer 76 such as a cushion sheet is provided between the display member 71 and the metal support 10. A heat dissipation layer 77 is disposed on, of the metal support 10, the opposite surface facing away from the display member 71. The display member 71, the cushioning layer 76, the metal support 10, and the heat dissipation layer 77 are supported by the casing 78.

The display member 71 includes a supporting base material 72, a thin-film transistor (TFT) 73, an organic EL element 74, and a sealing resin 75. The thin-film transistor 73 is disposed on the supporting base material 72. The organic EL element 74 is disposed on the thin-film transistor 73. The sealing resin 75 is disposed on the organic EL element 74.

The supporting base material 72 supports the entirety of the display member 71, and may be a film that has flexibility. A synthetic resin material such as, for example, polyethylene terephthalate may be used as the supporting base material 72. The thin-film transistor 73 drives the organic EL element 74, and controls a voltage applied to an electrode of the organic EL element 74. The organic EL element 74 displays an image and the like by self-emission of light. The organic EL element 74 is electrically connected to the thin-film transistor 73. The organic EL element 74 may be called “light emitting section”. The organic EL element 74 may include a non-illustrated reflection electrode, a non-illustrated organic light emission layer, and a non-illustrated transparent electrode. The sealing resin 75 seals the organic EL element 74, and protects the organic EL element 74. The display member 71 is not limited to an organic EL display device. For example, the display member 71 may be another type of display device that has a self-emission function. The display member 71 may be a micro LED display device that includes micro LED elements (light-emitting body).

The cushioning layer 76 is a layer that mitigates the stress applied to the display member 71 when the flexible display device 70 is folded. The cushioning layer 76 may be a layer of a resin material that has elasticity, such as a silicone resin, a polyurethane resin, or an epoxy-based resin. The metal support 10 is a member that enhances bending strength when the flexible display device 70 is folded. The configuration of the metal support 10 will be described later.

The heat dissipation layer 77 is a layer that releases heat from the display member 71 to the outside. The heat dissipation layer 77 may be a layer made of metal such as copper or nickel. The heat dissipation layer 77 may be a plated layer produced through electrolytic plating. The casing 78 houses and protects the display member 71, the cushioning layer 76, the metal support 10, and the heat dissipation layer 77. The casing 78 has a structure of being foldable at its center along the folding center line FL.

There are a bending area BA and non-bending areas NA in the flexible display device 70. The bending area BA is an area of physical deformation when the flexible display device 70 is in a folded state (see FIG. 4). The folding center line FL is located at substantially the center of the bending area BA. The non-bending area NA is an area that is substantially free from deformation when the flexible display device 70 is in a folded state (see FIG. 4). In the first direction D1, the non-bending areas NA exist respectively on both sides with respect to the bending area BA. The two non-bending areas NA may have substantially the same length in the first direction D1. This does not imply any limitation. The two non-bending areas NA may have lengths different from each other in the first direction D1. The bending area BA exists at the center of the flexible display device 70 in the first direction D1. This does not imply any limitation. The bending area BA may be located at any position other than the center of the flexible display device 70 in the first direction D1.

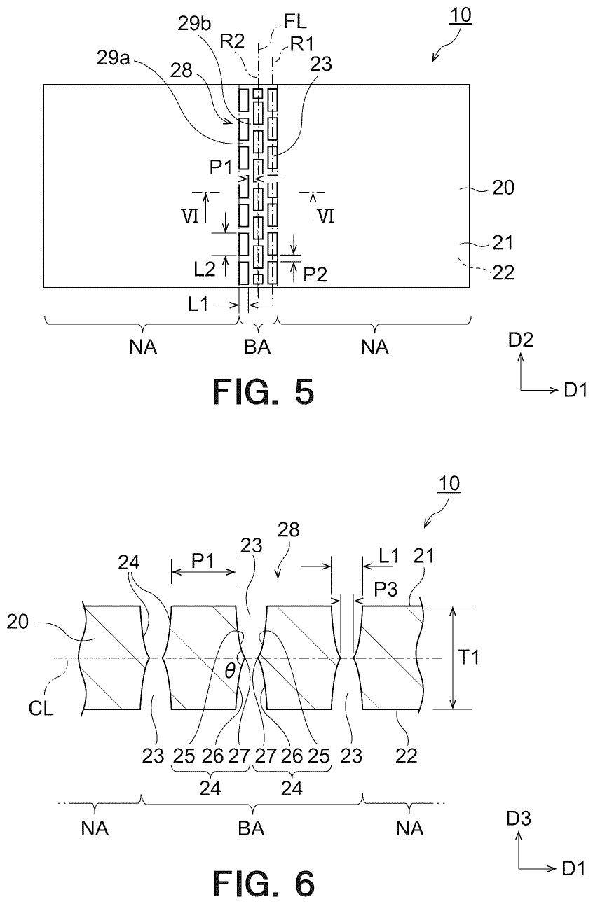

Configuration of Flexible Display Device Metal Support Next, with reference to FIGS. 5 and 6, an overview of a flexible display device metal support according to the present embodiment is presented below. FIGS. 5 and 6 are diagrams illustrating a flexible display device metal support according to the present embodiment.

As illustrated in FIGS. 5 and 6, the metal support 10 includes a base material 20. The base material 20 has a first surface 21 and a second surface 22. The first surface 21 is a surface facing toward the display member 71 of the flexible display device 70. The second surface 22 is a surface facing toward the heat dissipation layer 77 of the flexible display device 70. Each of the first surface 21 and the second surface 22 is parallel to a plane formed by an axis of the first direction D1 and an axis of the second direction D2. The base material 20 includes each through hole 23 and at least two through-hole sidewall surfaces 24 and 24 facing each other, with the through hole 23 located therebetween. Each of the two through-hole sidewall surfaces 24 and 24 includes a first-surface-side taper surface 25 formed in such a manner that the through hole 23 becomes wider from the side where the second surface 22 is located toward the side where the first surface 21 is located. In addition, each of the two through-hole sidewall surfaces 24 and 24 includes a second-surface-side taper surface 26 formed in such a manner that the through hole 23 becomes wider from the side where the first surface 21 is located toward the side where the second surface 22 is located.

There are a bending area BA and non-bending areas NA in the metal support 10. The bending area BA is an area of physical deformation when the flexible display device 70 is in a folded state (see FIG. 4). The folding center line FL is located at substantially the center of the bending area BA. The non-bending area NA is an area that is substantially free from deformation when the flexible display device 70 is in a folded state (see FIG. 4). The bending area BA and the non-bending area NA correspond respectively to the bending area BA and the non-bending area NA of the flexible display device 70 described above.

The base material 20 is a member that enhances bending strength when the flexible display device 70 is folded. The base material 20 has a rectangular shape in a plan view. A pair of the longer sides of this rectangle is parallel to the first direction D1, and a pair of the shorter sides of this rectangle is parallel to the second direction D2. Note that this does not imply any limitation. A pair of the shorter sides may be parallel to the first direction D1, and a pair of the longer sides may be parallel to the second direction D2. Each corner portion of this rectangle may be rounded. The base material 20 may have a square shape, a polygonal shape, or a circular shape in a plan view. The planar shape of the base material 20 may correspond to the planar shape of the flexible display device 70. In this case, the planar shape of the base material 20 may be the same as the planar shape of the flexible display device 70. Alternatively, the planar shape of the base material 20 may be smaller than the planar shape of the flexible display device 70.

The base material 20 has a flexible, bendable, and thin shape. In this specification, the term “flexible” means “the ability to be bent to a radius of curvature of at most 5.0 mm or less, or more preferably, 3.0 mm or less.

The thickness T1 of the base material 20 may be 50 μm or greater, or may be 75 μm or greater. By designing the thickness T1 of the base material 20 to be 50 μm or greater, it is possible to suppress the base material 20 failing to fulfill its function as a support due to an insufficient strength. The thickness T1 of the base material 20 may be 150 μm or less. By designing the thickness T1 of the base material 20 to be 150 μm or less, it is possible to make the radius of curvature at the bending area BA small and improve bending resistance. Moreover, it is possible to suppress excessive heaviness of the metal support 10.

The base material 20 is made of metal. The base material 20 contains a principal metal material. An iron alloy such as stainless steel, or titanium, may be used as the principal metal material of the base material 20. In a case where stainless steel is used as the principal metal material of the base material 20, it is easier to bend the base material 20 because the base material 20 has good spring property. In this specification, the term “principal metal material” means a metal material whose content in a certain member is in excess of 50 percent by mass, or more preferably, in excess of 80 percent by mass.

The base material 20 includes a patterned portion 28. The patterned portion 28 is provided at a position corresponding to the bending area BA. The patterned portion 28 has a mesh shape. A plurality of through holes 23 is located in the patterned portion 28. In this case, the patterned portion 28 may be formed of a single member. The patterned portion 28 includes a first direction portion 29a extending in the first direction and a second direction portion 29b extending in the second direction. Each through hole 23 is formed in such a way as to be surrounded by the first direction portion 29a and the second direction portion 29b. The plurality of through holes 23 includes through holes 23 on a first row R1 spaced apart from one another in the second direction D2 and through holes 23 on a second row R2 spaced apart from one another in the second direction D2. The through holes 23 on the first row R1 and the through holes 23 on the second row R2 are arranged with a shift in the second direction D2. That is, the respective center points of the through holes 23 are arranged in a rhombic lattice layout. In this case, since the plurality of through holes 23 is arranged in a staggered manner, it is possible to mitigate stress concentration at a particular portion in when the flexible display device 70 is folded. The respective center points of the through holes 23 may be arranged in a square lattice layout or a rectangular lattice layout.

The patterned portion 28 may have a line shape. In this case, the patterned portion 28 has a plurality of line-shaped sections at an area corresponding to the bending area BA. Each of the line-shaped sections may extend like a line in the second direction D2. The plurality of line-shaped sections may be spaced apart from one another in the first direction D1. The through hole 23 is formed each between the plurality of line-shaped sections. The above description does not imply any limitation. Each of the plurality of line-shaped sections may extend in the first direction D1.

The pitch P1 of the through holes 23 arranged adjacent to each other in the first direction D1 may be 5 μm or greater, or 10 μm or greater. The pitch P1 of the through holes 23 arranged adjacent to each other in the first direction D1 may be 500 μm or less, or 100 μm or less. The pitch P2 of the through holes 23 arranged adjacent to each other in the second direction D2 may be 5 μm or greater, or 10 μm or greater. The pitch P2 of the through holes 23 arranged adjacent to each other in the second direction D2 may be 500μm or less, or 100 μm or less. Each of the pitch P1 and the pitch P2 refers to a distance on the first surface 21.

Each of the through holes 23 has a substantially rectangular shape in a plan view. This does not imply any limitation. Each of the through holes 23 may have, for example, a polygonal shape or a circular shape in a plan view. Each of the through holes 23 may have a rectangular shape with rounded corners in a plan view. The length L1 of each of the through holes 23 in the first direction D1 may be 5 μm or greater, or 10 μm or greater. The length L1 of each of the through holes 23 in the first direction D1 may be 500μm or less, or 100 μm or less. The length L2 of each of the through holes 23 in the second direction D2 may be 5 μm or greater, or 10 μm or greater. The length L2 of each of the through holes 23 in the second direction D2 may be 500 μm or less, or 100 μm or less. Each of the length L1 and the length L2 refers to a distance on the first surface 21.

Next, with reference to FIG. 6, a cross-sectional shape of the metal support 10 will now be described.

As illustrated in FIG. 6, the base material 20 includes the through hole(s) 23 and at least two through-hole sidewall surfaces 24 and 24. The two through-hole sidewall surfaces 24 and 24 face each other, with the through hole 23 located therebetween. Each of the through-hole sidewall surfaces 24 and 24 constitutes a part of the perimeter of the through hole 23. Each of the through-hole sidewall surfaces 24 and 24 includes the first-surface-side taper surface 25, the second-surface-side taper surface 26, and a lateral protrusion 27.

The first-surface-side taper surface 25 is formed in such a manner that the through hole 23 becomes wider each from the side where the second surface 22 is located toward the side where the first surface 21 is located. The first-surface-side taper surface 25 is located between the first surface 21 and the lateral protrusion 27. One end of the first-surface-side taper surface 25 in the thickness direction (third direction D3) lies at the first surface 21. The other end of the first-surface-side taper surface 25 in the thickness direction lies at the lateral protrusion 27. The first-surface-side taper surface 25 is sloped toward the core of the through hole 23 from the side where the first surface 21 is located toward the side where the lateral protrusion 27 is located. In a cross section perpendicular to the first surface 21 and the second surface 22 (FIG. 6), the first-surface-side taper surface 25 is curved in a direction of going away from the through hole 23. The first-surface-side taper surface 25 may extend linearly in the cross section perpendicular to the first surface 21 and the second surface 22.

The second-surface-side taper surface 26 is formed in such a manner that the through hole 23 becomes wider each from the side where the first surface 21 is located toward the side where the second surface 22 is located. The second-surface-side taper surface 26 is located between the lateral protrusion 27 and the second surface 22. One end of the second-surface-side taper surface 26 in the thickness direction (third direction D3) lies at the lateral protrusion 27. The other end of the second-surface-side taper surface 26 in the thickness direction lies at the second surface 22. The second-surface-side taper surface 26 is sloped toward the core of the through hole 23 from the side where the second surface 22 is located toward the side where the lateral protrusion 27 is located. In a cross section perpendicular to the first surface 21 and the second surface 22 (FIG. 6), the second-surface-side taper surface 26 is curved in a direction of going away from the through hole 23. The second-surface-side taper surface 26 may extend linearly in the cross section perpendicular to the first surface 21 and the second surface 22.

The lateral protrusion 27 is formed between the first-surface-side taper surface 25 and the second-surface-side taper surface 26. The lateral protrusion 27 protrudes toward the core of the through hole 23. In a cross section perpendicular to the first surface 21 and the second surface 22 (FIG. 6), the angle θ formed by each of the lateral protrusions 27 may be 30° or greater and 180° or less. The lateral protrusions 27 formed respectively on the two through-hole sidewall surfaces 24 and 24 face each other. The pitch P3 in the first direction D1 between the lateral protrusions 27 facing each other may be 4 μm or greater, or 9 μm or greater. The pitch P3 in the first direction D1 between the lateral protrusions 27 facing each other may be 400 μm or less, or 90 μm or less. The pitch P3 is less than the length L1 (P3<L1) In the thickness direction (third direction D3) of the base material 20, the lateral protrusion 27 is located at the midpoint between the first surface 21 and the second surface 22. That is, the lateral protrusion 27 is located on the centerline CL between the first surface 21 and the second surface 22. In this case, it is possible to suppress the interference of the through-hole sidewall surfaces 24 and 24 with each other not only when the metal support 10 is folded with the first surface 21 oriented inward, but also when the metal support 10 is folded with the second surface 22 oriented inward.

It is preferable if, at least in a cross section parallel to the first direction D1, each of the two through-hole sidewall surfaces 24 and 24 includes the first-surface-side taper surface 25, the second-surface-side taper surface 26, and the lateral protrusion 27. This makes it possible to suppress the mutual interference of the two through-hole sidewall surfaces 24 and 24 facing each other when the metal support 10 is bent, with the folding center line FL parallel to the second direction D2 serving as the center of the bending. By this means, it is possible to cause the bending area BA of the metal support 10 to follow the bending of the metal support 10 easily. This results in a reduction in the radius of curvature at the bending area BA. Also in a cross section parallel to the second direction D2, each of the two through-hole sidewall surfaces 24 and 24 may include the first-surface-side taper surface 25, the second-surface-side taper surface 26, and the lateral protrusion 27. The first-surface-side taper surface 25, the second-surface-side taper surface 26, and the lateral protrusion 27 may be formed throughout the entire perimeter of the through hole 23. Alternatively, in a cross section parallel to the second direction D2, each of the two through-hole sidewall surfaces 24 and 24 may be perpendicular to the first surface 21 and the second surface 22.

The pitch P1 of the through holes 23 arranged adjacent to each other and/or the shape of the plurality of through holes 23 may be uniform. Alternatively, the pitch P1 of the through holes 23 arranged adjacent to each other and/or the shape of the plurality of through holes 23 may vary from one location of the through hole 23 to another. For example, the pitch P1 of the through holes 23 arranged adjacent to each other near the folding center line FL may be designed to be wider than the pitch P1 of the through holes 23 arranged adjacent to each other away from the folding center line FL. The shape of the through holes 23 arranged near the folding center line FL may be designed to be larger than the shape of the through holes 23 arranged away from the folding center line FL. This makes it possible to suppress the mutual interference of the through-hole sidewall surfaces 24 and 24 of the through hole 23 located near the folding center line FL at a position where the radius of curvature tends to be small when the metal support 10 is folded.

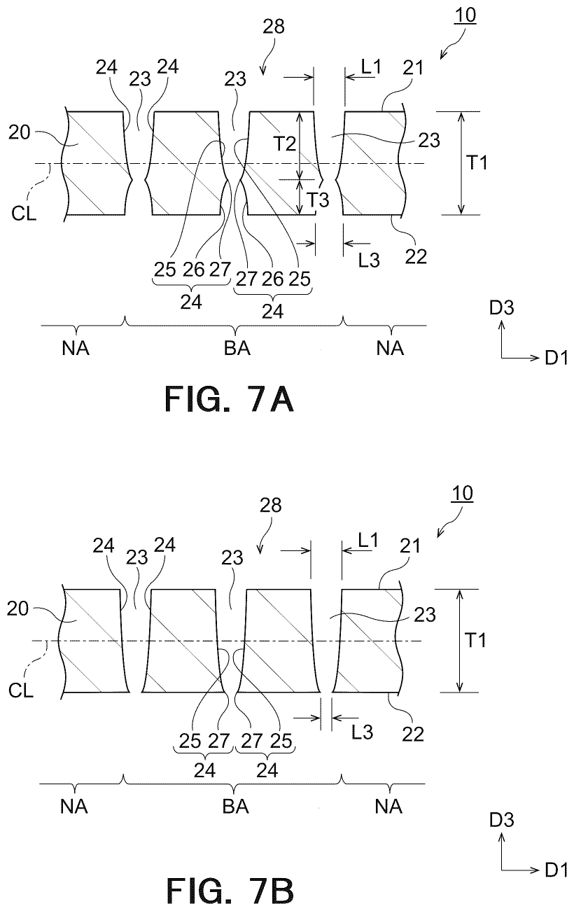

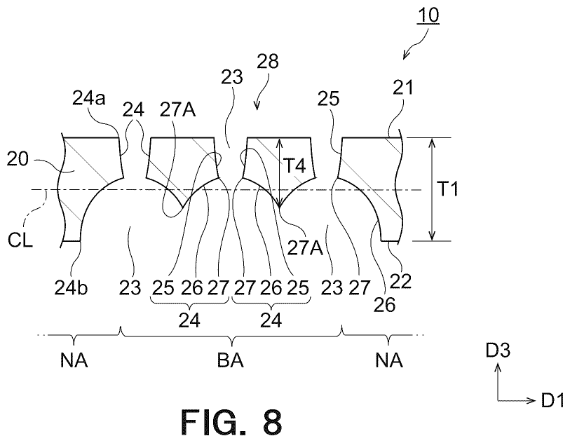

FIGS. 7A, 7B, and 8 are cross-sectional views illustrating the metal support 10 according to variation examples respectively.

As illustrated in FIG. 7A, the lateral protrusion 27 may be located at a position closer to the second surface 22 than the centerline CL between the first surface 21 and the second surface 22 is. That is, the distance T2 of the first-surface-side taper surface 25 in the thickness direction (third direction D3) is greater than the distance T3 of the second-surface-side taper surface 26 in the thickness direction (T2>T3). The distance T3 of the second-surface-side taper surface 26 in the thickness direction may be 10% or greater but less than 50% of the thickness T1 of the base material 20. With regard to the length of each of the through holes 23 in the first direction D1, the length L3 at the second surface 22 may be less than the length L1 at the first surface 21 (L1>L3). Alternatively, the length L1 at the first surface 21 of each of the through holes 23 may be equal to the length L3 at the second surface 22 of each of the through holes 23 (L1=L3). The length L3 at the second surface 22 of each of the through holes 23 may be 10% or greater and 100% or less of the length L1 at the first surface 21 thereof. According to the present variation example, the distance T2 of the first-surface-side taper surface 25 in the thickness direction is greater than the distance T3 of the second-surface-side taper surface 26 in the thickness direction. Therefore, it is possible to suppress the mutual interference of the two through-hole sidewall surfaces 24 and 24 facing each other more effectively when the metal support 10 is folded, with the first surface 21 oriented inward, and with the folding center line FL serving as the center of the folding.

As illustrated in FIG. 7B, each of the through-hole sidewall surfaces 24 and 24 may be designed to include the first-surface-side taper surface 25 without the second-surface-side taper surface 26. In this case, the first-surface-side taper surface 25 is formed throughout the entirety of the base material 20 in the thickness direction. That is, one end of the first-surface-side taper surface 25 in the thickness direction lies at the first surface 21, and the other end of the first-surface-side taper surface 25 in the thickness direction lies at the second surface 22. The lateral protrusion 27 is formed at the other end of the first-surface-side taper surface 25 in the thickness direction. The lateral protrusion 27 protrudes toward the core of the through hole 23. With regard to the length of each of the through holes 23 in the first direction D1, the length L3 at the second surface 22 is less than the length L1 at the first surface 21 (L1>L3). The length L3 at the second surface 22 of each of the through holes 23 may be 10% or greater but less than 100% of the length L1 at the first surface 21 thereof. According to the present variation example, the first-surface-side taper surface 25 is formed throughout the entirety of the base material 20 in the thickness direction. Therefore, it is possible to suppress the mutual interference of the two through-hole sidewall surfaces 24 and 24 facing each other more effectively when the metal support 10 is folded, with the first surface 21 oriented inward, and with the folding center line FL serving as the center of the folding.

As illustrated in FIG. 8, the thickness T1 of the base material 20 at the non-bending area NA and the thickness T4 of the base material 20 at the bending area BA may be different from each other. Specifically, the thickness T1 of the base material 20 at the non-bending area NA may be greater than the thickness T4 of the base material 20 at the bending area BA. The thickness T4 of the base material 20 at the bending area BA means the maximum thickness of the portion existing within the bending area BA of the base material 20. In other words, this thickness means the maximum thickness of the base material 20 within the area located between, among the through holes 23, the one located closest to one of the non-bending areas NA and the one located closest to the other of the non-bending areas NA. The thickness T1 of the base material 20 at the non-bending area NA may be 75 μm or greater and 150 μm or less. The thickness T4 of the base material 20 at the bending area BA may be 10 μm or greater and 30 μm or less.

In FIG. 8, each of the through-hole sidewall surfaces 24 and 24 of the base material 20 includes the first-surface-side taper surface 25, the second-surface-side taper surface 26, and the lateral protrusion 27. The first-surface-side taper surface 25 is formed in such a manner that the through hole 23 becomes wider each from the side where the second surface 22 is located toward the side where the first surface 21 is located. The second-surface-side taper surface 26 is formed in such a manner that the through hole 23 becomes wider each from the side where the first surface 21 is located toward the side where the second surface 22 is located. The lateral protrusion 27 protrudes toward the core of the through hole 23. The lateral protrusion 27 may be located at a position closer to the first surface 21 than the centerline CL between the first surface 21 and the second surface 22 is.

In the bending area BA, a second-surface-side protrusion 27A is formed at the side, of the base material 20, where the second surface 22 is located. The second-surface-side protrusion 27A protrudes toward the second surface 22. The tip of the second-surface-side protrusion 27A is located at a position closer to the first surface 21 than the second surface 22 is. The tip of the second-surface-side protrusion 27A may be located at a position closer to the second surface 22 than the centerline CL between the first surface 21 and the second surface 22 is. Alternatively, the tip of the second-surface-side protrusion 27A may be located at a position closer to the first surface 21 than the centerline CL is. In the bending area BA, the second-surface-side taper surface 26 is located between the lateral protrusion 27 and the second-surface-side protrusion 27A. The second-surface-side taper surface 26 is continuous to another second-surface-side taper surface 26 via the second-surface-side protrusion 27A. In the bending area BA, the second-surface-side taper surface 26 and/or the second-surface-side protrusion 27A may be absent.

The through-hole sidewall surface 24 located closest to the non-bending area NA has an end 24a at the first surface 21 and an end 24b at the second surface 22. In this case, the end 24a at the first surface 21 may be located closer to the bending area BA than the end 24b at the second surface 22 is.

According to the variation example illustrated in FIG. 8, the thickness T4 of the base material 20 at the bending area BA is less than the thickness T1 of the base material 20 at the non-bending area NA. This makes it possible to further reduce the radius of curvature at the bending area BA when the metal support 10 is folded. Moreover, it is possible to enhance the bending strength of the metal support 10. The thickness T1 of the base material 20 at the non-bending area NA may be less than the thickness T4 of the base material 20 at the bending area BA. In this case, it is possible to improve the durability of the base material 20 at the bending area BA.

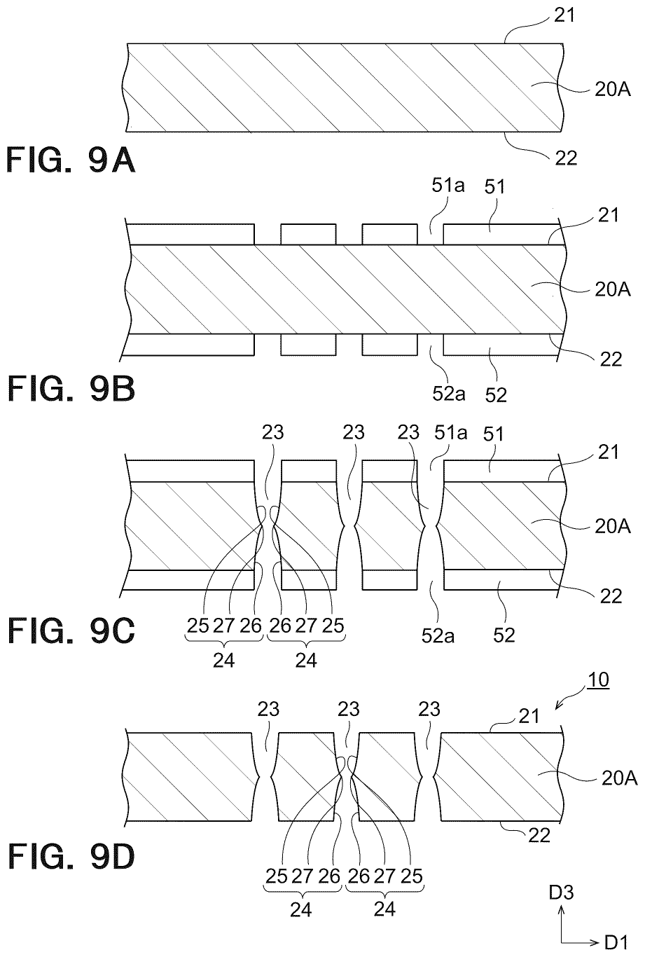

Method of Manufacturing Flexible Display Device Metal Support Next, with reference to FIGS. 9A to 9D, a method of manufacturing the metal support 10 illustrated in FIGS. 5 and 6 will now be described.

First, as illustrated in FIG. 9A, a flat-plate-like base material 20A having not been etched is prepared. An iron alloy such as stainless steel, or titanium, may be used as the base material 20A. The base material 20A has a first surface 21 and a second surface 22. A substrate whose first surface 21 and second surface 22 have been cleaned by performing degreasing or the like thereon may be used as the base material 20A.

Next, as illustrated in FIG. 9B, a first protection layer 51 and a second protection layer 52 are provided on the base material 20A. Specifically, the first protection layer 51 having first protection layer openings 51a is provided on the first surface 21 of the base material 20A, and the second protection layer 52 having second protection layer openings 52a is provided on the second surface 22 of the base material 20A. Each of the first protection layer 51 and the second protection layer 52 may be a resist layer. In this case, first, a photosensitive resist is applied to the entirety of each of the first surface 21 and the second surface 22 of the base material 20A, and the photosensitive resist is dried. After the resist application and the resist drying, the photosensitive resist on each of the first surface 21 and the second surface 22 of the base material 20A is exposed to light, with a photomask interposed therebetween, for development. Through this process, the first protection layer 51 having the first protection layer openings 51a is formed on the first surface 21 of the base material 20A, and the second protection layer 52 having the second protection layer openings 52a is formed on the second surface 22 thereof. The planar shape of the first protection layer opening 51a and the planar shape of the second protection layer opening 52a correspond to the planar shape of the through hole 23.

Next, as illustrated in FIG. 9C, etching is applied to the first surface 21 of the base material 20A by using an etchant, with the first protection layer 51 serving as an etching-resistant coat. Similarly, etching is applied to the second surface 22 of the base material 20A by using an etchant, with the second protection layer 52 serving as an etching-resistant coat. The etchant can be selected as appropriate, depending on the material of which the base material 20A is made. For example, in a case where stainless steel is used as the base material 20A, a mixed liquid that contains ferric chloride as a chief constituent with hydrochloric acid, or a mixed liquid that further contains nitric acid in addition thereto, may be used as the etchant. The etchant described above may be spray-etched onto the base material 20A. Through this process, the base material 20A is etched from both of the first surface 21 and the second surface 22, and the through holes 23 going through the base material 20A are formed. At this time, the two through-hole sidewall surfaces 24 and 24 facing each other, with the through hole 23 located therebetween, are formed in the base material 20A. In the etching, the base material 20A is treated isotropically in the thickness direction and the width direction. Therefore, the first-surface-side taper surface 25 is formed in each of the two through-hole sidewall surfaces 24 and 24 in such a manner that the through hole 23 becomes wider from the side where the second surface 22 is located toward the side where the first surface 21 is located. Similarly, the second-surface-side taper surface 26 is formed in each of the two through-hole sidewall surfaces 24 and 24 in such a manner that the through hole 23 becomes wider from the side where the first surface 21 is located toward the side where the second surface 22 is located.

After that, as illustrated in FIG. 9D, each of the first protection layer 51 on the first surface 21 of the base material 20A and the second protection layer 52 on the second surface 22 of the base material 20A is removed. In this way, the metal support 10 illustrated in FIGS. 5 and 6 are obtained.

As described above, according to the present embodiment, each of the two through-hole sidewall surfaces 24 and 24 of the base material 20 includes the first-surface-side taper surface 25. The first-surface-side taper surface 25 is formed in such a manner that the through hole 23 becomes wider from the side where the second surface 22 is located toward the side where the first surface 21 is located. Therefore, when the metal support 10 is built into the flexible display device 70, it is possible to enhance the bendability of the bending area BA of the flexible display device 70. Consequently, it is possible to further reduce the shape at the bending area BA when the flexible display device 70 is folded. That is, it is possible to further reduce the radius of curvature at the bending area BA.

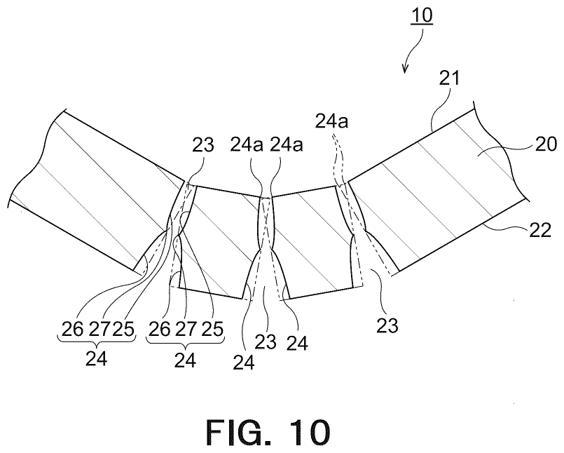

Moreover, according to the present embodiment, the through hole 23 becomes wider toward the first surface 21. Therefore, it is possible to suppress the interference of the respective ends 24a at the first surface 21 of the through-hole sidewall surfaces 24 and 24 with each other when the metal support 10 is folded, with the first surface 21 of the base material 20 of the metal support 10 oriented inward, as illustrated in FIG. 10. Consequently, it is possible to further reduce the radius of curvature at the bending area BA when the flexible display device 70 is folded. By contrast, as indicated by virtual lines illustrating a comparative example in FIG. 10, in a case where the through hole 23 does not have a structure of becoming wider toward the first surface 21, there is a risk of the interference of the respective ends 24a at the first surface 21 of the through-hole sidewall surfaces 24 and 24 with each other when the metal support 10 is folded.

Moreover, according to the present embodiment, since the plurality of through holes 23 is formed in the base material 20, it is possible to enhance the bendability of the bending area BA of the flexible display device 70 when the metal support 10 is built into the flexible display device 70. Furthermore, since the plurality of through holes 23 is formed in the base material 20, it is possible to make the metal support 10 lighter in weight.

In addition, according to the present embodiment, each of the two through-hole sidewall surfaces 24 and 24 includes the second-surface-side taper surface 26 formed in such a manner that the through hole 23 becomes wider from the side where the first surface 21 is located toward the side where the second surface 22 is located. Therefore, it is possible to suppress the interference of the respective ends at the second surface 22 of the through-hole sidewall surfaces 24 and 24 with each other also when the metal support 10 is folded, with the second surface 22 of the base material 20 of the metal support 10 oriented inward.

Moreover, according to the present embodiment, the lateral protrusion 27 is formed between the first-surface-side taper surface 25 and the second-surface-side taper surface 26. In this case, it is possible to shorten the pitch P3 between the lateral protrusions 27 facing each other, thereby suppressing a decrease in the strength of the metal support 10 due to the excessive widening of the through hole 23.

The plurality of components disclosed in the foregoing embodiments and the variation examples can be combined together as needed. Alternatively, some of all of the components disclosed in the foregoing embodiments and the variation examples may be deleted.

1. A flexible display device metal support, comprising:
a base material having a first surface and a second surface, the base material including:
a through hole; and
at least two through-hole sidewall surfaces facing each other, with the through hole therebetween, wherein
each of the two through-hole sidewall surfaces includes a first-surface-side taper surface formed in such a manner that the through hole becomes wider from a side where the second surface is located toward a side where the first surface is located.

2. The flexible display device metal support according to claim 1, wherein each of the two through-hole sidewall surfaces includes a second-surface-side taper surface formed in such a manner that the through hole becomes wider from the side where the first surface is located toward the side where the second surface is located.

3. The flexible display device metal support according to claim 2, wherein a lateral protrusion is formed between the first-surface-side taper surface and the second-surface-side taper surface.

4. The flexible display device metal support according to claim 3, wherein the lateral protrusion is located at a midpoint between the first surface and the second surface.

5. The flexible display device metal support according to claim 3, wherein the lateral protrusion is located at a position closer to the second surface than a midpoint between the first surface and the second surface is.

6. The flexible display device metal support according to claim 1, including:
a bending area; and
a non-bending area, wherein
a thickness of the base material at the non-bending area and a thickness of the base material at the bending area are different from each other.

7. The flexible display device metal support according to claim 6, wherein in the bending area, a second-surface-side protrusion is formed at the side, of the base material, where the second surface is located.

8. A flexible display device, comprising:
a display member; and
the flexible display device metal support according to claim 1 supporting the display member.

9. A method of manufacturing a flexible display device metal support, comprising:
preparing a base material having a first surface and a second surface; and
forming a through hole and at least two through-hole sidewall surfaces facing each other, with the through hole therebetween, in the base material by etching the base material, wherein
each of the two through-hole sidewall surfaces includes a first-surface-side taper surface formed in such a manner that the through hole becomes wider from a side where the second surface is located toward a side where the first surface is located.
